(19) United States
(12) Patent Application Publication
(10) Pub. No.: US 2024/0193613 A1
(43) Pub. Date: Jun. 13, 2024

(54) AUTHORIZING PEER-TO-PEER PAYMENTS IN MESSAGING APPLICATIONS

(71) Applicant: WhatsApp LLC, Menlo Park, CA (US)

(72) Inventors: Biren Arvindkumar Patel, San Ramon, CA (US); Shipeng Xu, Union City, CA (US)

(21) Appl. No.: 18/063,614

(22) Filed: Dec. 8, 2022

(51) Int. Cl. G06Q 20/42; G06Q 20/22; G06Q 20/32; G06Q 20/40

(52) U.S. Cl. CPC G06Q 20/42; G06Q 20/223; G06Q 20/3255; G06Q 20/405

(57) ABSTRACT

A method for transferring funds in a peer-to-peer transaction through a messaging application is provided. The method includes receiving, in a server hosting a messaging application, a selection of a transaction recipient by a user of the messaging application, verifying a validity of the transaction based on at least one of a user attribute and a transaction recipient setting in the messaging application. When the transaction is validated, the method includes providing the user of the messaging application with an approval button for accepting the transaction, applying the transaction when the user of the messaging application accepts the transaction, and disabling the approval button when the transaction is not validated. A system including a memory storing instructions and one or more processors to execute the instructions and cause the system to perform the above method is also provided.

### BACKGROUND

### Field

The present disclosure is related to peer-to-peer transactions between participants in a messaging application. More specifically, the present disclosure is related to handling and authorizing funds transfer between two participants in a messaging application.

### Related Art

Current messaging applications do not allow an easy and seamless transfer of funds or payments between two participants via peer-to-peer communication within a chat event. In some approaches, when one of the participants desires to make a funds transfer, the system requests permission to both participants, and thus the provider immediately knows when the transfer is rejected by the recipient. This constitutes an unacceptable breach of the potential of the recipient's privacy. On the other hand, it is desirable to let the provider know that the funds transfer is invalidated, to guarantee the safety of the provider's information and funds.

### SUMMARY

In a first embodiment, a computer-implemented method includes receiving, in a server hosting a messaging application, a selection of a transaction recipient by a user of the messaging application, verifying a validity of the transaction based on at least one of a user attribute and a transaction recipient setting in the messaging application, when the transaction is validated, providing the user of the messaging application with an approval button for accepting the transaction, applying the transaction when the user of the messaging application accepts the transaction, and disabling the approval button when the transaction is not validated.

In a second embodiment, a system includes a memory storing multiple instructions, and one or more processors configured to execute the instructions to cause the system to perform operations. The operations include to receive, in a server hosting a messaging application, a selection of a transaction recipient by a user of the messaging application, to verify a validity of the transaction based on at least one of a user attribute and a transaction recipient setting in the messaging application, when the transaction is validated, provide the user of the messaging application with an approval button for accepting the transaction, apply the transaction when the user of the messaging application accepts the transaction; and disable the approval button when the transaction is not validated.

In a third embodiment, a computer-implemented method includes providing, with a client device, a request for a transaction with a recipient via a messaging application hosted by a remote server, receiving, from the remote server, a transaction authorization request based on at least one of a user attribute and a transaction recipient setting in the messaging application, the transaction authorization request comprising an approval button, and approving the transaction when the approval button is enabled by the remote server.

In other embodiments, a non-transitory, computer-readable medium stores instructions which, when executed by a computer, cause the computer to perform a method. The method includes receiving, in a server hosting a messaging application, a selection of a transaction recipient by a user of the messaging application, verifying a validity of the transaction based on at least one of a user attribute and a transaction recipient setting in the messaging application, when the transaction is validated, providing the user of the messaging application with an approval button for accepting the transaction, applying the transaction when the user of the messaging application accepts the transaction, and disabling the approval button when the transaction is not validated.

In yet other embodiments, a system includes a first means for storing instructions and a second means for executing the instructions to cause the system to perform a method. The method includes receiving, in a server hosting a messaging application, a selection of a transaction recipient by a user of the messaging application, verifying a validity of the transaction based on at least one of a user attribute and a transaction recipient setting in the messaging application, when the transaction is validated, providing the user of the messaging application with an approval button for accepting the transaction, applying the transaction when the user of the messaging application accepts the transaction, and disabling the approval button when the transaction is not validated.

These and other embodiments will become clear to one of ordinary skill in the art, in light of the following.

### BRIEF DESCRIPTION OF THE FIGURES

FIG. 1 illustrates a network architecture configured to authorizing peer-to-peer payments in messaging applications, according to some embodiments.

FIG. 2 is a block diagram illustrating details of a client device and a server as used in the network architecture of FIG. 1, according to some embodiments.

FIGS. 3A-3C illustrate screenshots from a messaging application used for peer-to-peer fund transfer between a user and a recipient, according to some embodiments.

FIG. 4 is a flowchart illustrating steps in a method for handling a peer-to-peer fund transfer between a user and a recipient from a messaging application server, according to some embodiments.

FIG. 5 is a flowchart illustrating steps in a method for transferring funds from a client device using a peer-to-peer messaging application, according to some embodiments.

FIG. 6 is a flowchart illustrating steps in a method for transferring funds from a client device using a peer-to-peer messaging application, according to some embodiments.

FIG. 7 is a block diagram illustrating a computer system implemented in the network architecture of FIGS. 1 and 2, and to perform at least some of the steps in the method of FIGS. 4 and 5, according to some embodiments.

In the figures, reference elements having the same or similar reference numerals are associated with the same or similar attributes and features, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In particular embodiments, one or more objects (e.g., content or other types of objects) of a computing system may be associated with one or more privacy settings. The one or more objects may be stored on or otherwise associated with any suitable computing system or application, such as, for example, a messaging application or any other suitable computing system or application. Although the examples discussed herein are in the context of a messaging application, these privacy settings may be applied to any other suitable computing system. Privacy settings (or “access settings”) for a user of the messaging application may be stored in any suitable manner, such as, for example, in association with the user, in an index on an authorization server, in another suitable manner, or any suitable combination thereof. A privacy setting for a first user may block a second user of the messaging application to send messages to the first user. As an example and not by way of limitation, a first user of the messaging application may specify privacy settings for a user-profile page that identify a set of users that are blocked from sending messages to the first user. In particular embodiments, the blocked list may include third-party entities.

### General Overview

The simplicity and ubiquitous nature of messaging has broadened the applications of messaging applications, including peer-to-peer payments. In typical messaging applications, when a user has blocked receiving messages from another user, messaging applications allow the sender to send messages, even though the message is not sent to the recipient. This ensures that the sender does not know that the receiver has blocked the sender, thus protecting the sender's privacy. However, when a blocked sender attempts to send a payment transaction to the receiver, the said behavior is not ideal because money may be deducted from a sender's account. Most implementations currently show some error message to the blocked sender, or simply show that the payment is “being processed.” In some situations, the payment amount may be deducted from the blocked sender's account, and later refunded to the blocked sender. However, this situation is far from ideal for the blocked sender, who remains in the dark as to what exactly happened, and who may have to perform additional steps to recover the funds.

To resolve the above problem arising in the technical field of computer networks, the present disclosure includes a messaging authorization step that verifies a priori whether a sender is authorized to send a message to the recipient. In some embodiments, verification could happen during the flow, when the sender is attempting to compose a payment message. When the authorization fails (e.g., the sender is blocked by the receiver), then a graceful message is shown to the sender, and the user interface simply prevents the blocked user from initiating a payment. If the verification confirms that the sender is not blocked by the recipient, the payment message is sent seamlessly.

Accordingly, in some embodiments, the sender selects a recipient to transfer funds using a messaging application. An authorization request is sent from a client device with the sender to a server hosting the messaging application. The server verifies the validity of the transaction because the server can see whether the recipient has blocked the sender from the privacy settings of the recipient. When the recipient's privacy settings have blocked the sender, the server grays out or disables the button to attach a payment in the sender's client device. The fund transfer fails and is not carried through (no funds are taken or held from the sender's account). In some embodiments, a message is pushed to the sender, indicating the failed status of the transaction. When the server sees an open path between sender and recipient, it directs the client device with the sender to display a button to proceed with the payment. Once the payment is completed, the server pushes a message to the client device with the sender confirming the transaction has succeeded.

### Example System Architecture

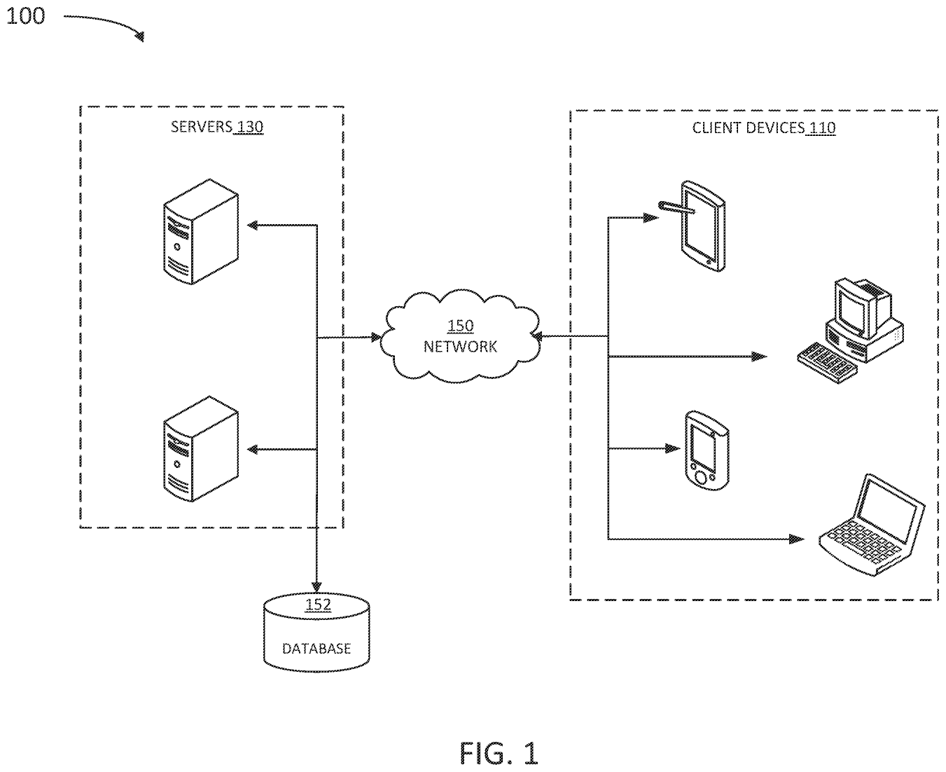

FIG. 1 illustrates a network architecture configured to authorizing peer-to-peer payments in messaging applications, according to some embodiments. Architecture 100 includes servers 130 communicatively coupled with client devices 110 and at least one database 152 over a network 150. One of the many servers 130 is configured to host a memory including instructions which, when executed by a processor, cause the server 130 to perform at least some of the steps in methods as disclosed herein. In some embodiments, the processor is configured to control a graphical user interface (GUI) for the user of one of client devices 110 accessing a chat engine with a messaging application. Accordingly, the processor may include a dashboard tool, configured to display components and graphic results to the user via the GUI. For purposes of load balancing, multiple servers 130 can host memories including instructions to one or more processors, and multiple servers 130 can host a history log and a database 152 including multiple training archives used for the chat engine. In some embodiments, a single user with a single client device 110 may provide a fund transfer to a second user of the messaging application. Accordingly, client devices 110 and servers 130 may communicate with each other via network 150 and resources located therein, such as data in database 152.

Servers 130 may include any device having an appropriate processor, memory, and communications capability for hosting the chat engine including multiple tools associated with it. The chat engine may be accessible by various clients 110 over network 150. Client devices 110 can be, for example, desktop computers, mobile computers, tablet computers (e.g., including e-book readers), mobile devices (e.g., a smartphone or PDA), or any other device having appropriate processor, memory, and communications capabilities for accessing the chat engine on one or more of servers 130. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

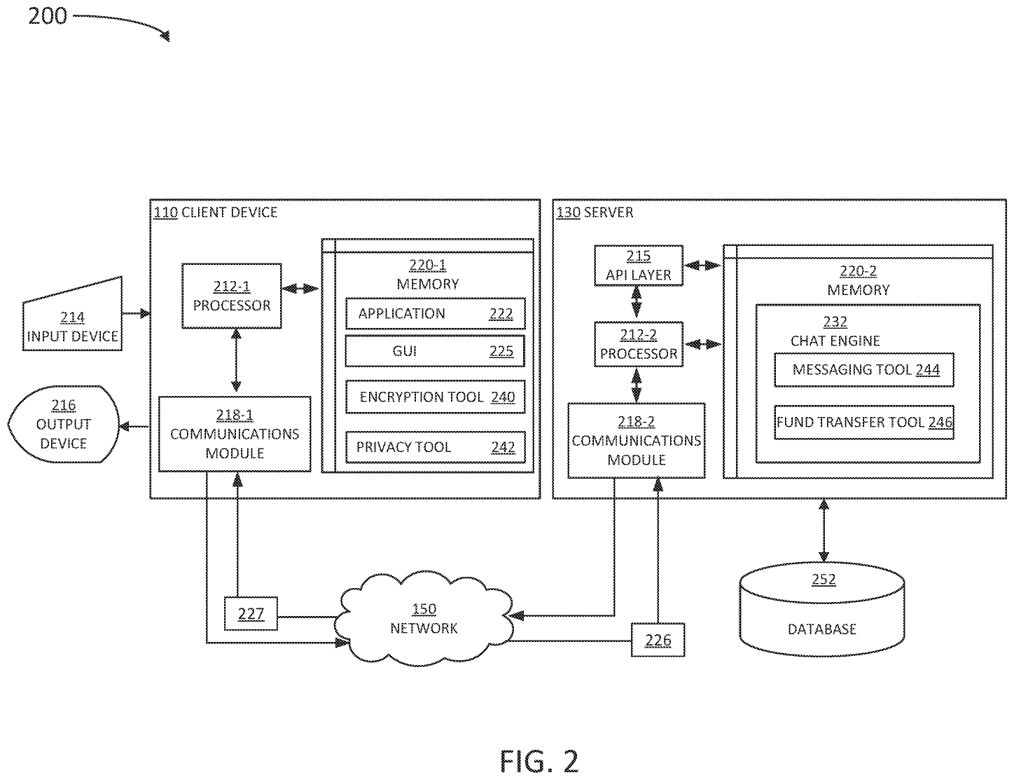

FIG. 2 is a block diagram 200 illustrating an example server 130 and client device 110 from architecture 100, according to certain aspects of the disclosure. Client device 110, server 130, and database 252 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices via network 150. Communications modules 218 can be, for example, modems or Ethernet cards, and may include radio hardware and software for wireless communications (e.g., via electromagnetic radiation, such as radiofrequency—RF—, near field communications—NFC—, Wi-Fi, and Bluetooth radio technology). A user may interact with client device 110 via an input device 214 and an output device 216. Input device 214 may include a mouse, a keyboard, a pointer, a touchscreen, a microphone, a joystick, a virtual joystick, and the like. In some embodiments, input device 214 may include cameras, microphones, and sensors, such as touch sensors, acoustic sensors, inertial motion units—IMUs—and other sensors. For example, in some embodiments, input device 214 may include an eye tracking device to detect the position of a user's pupil in a VR/AR headset. Output device 216 may be a screen display, a touchscreen, a speaker, and the like. Client device 110 may include a memory 220-1 and a processor 212-1. Memory 220-1 may include a messaging application 222, configured to run in client device 110 and a graphic user interface (GUI 225) coupled with input device 214 and output device 216. Application 222 may be downloaded by the user from server 130 and may be hosted by server 130. GUI 225 may be instructed by server 130 to display messages, notifications, and other interactive widgets for the user of client device 110.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes a chat engine 232. Chat engine 232 may share with, or provide features and resources to, client device 110, including multiple tools associated with fund transfer and other peer-to-peer transactions. The user may access chat engine 232 through application 222, installed in memory 220-1 of client device 110. Accordingly, application 222 may be installed by server 130 and perform scripts and other routines provided by server 130 through any one of multiple tools via an application programming interface (API) layer 215. Execution of application 222 may be controlled by processor 212-1. Encryption tool 240 encrypts data 226 and decrypts data 227 to ensure that the privacy and security of each of the participants in a group chat is secure and remains private. Privacy tool 242 ensures that the privacy of the chat participants is maintained. For example, privacy tool 242 may include a list of subscribers to messaging application 222 that a user of client device 110 has blocked from providing messages and data 227. Privacy tool 242 may also store other information such as account numbers for fund accounts (e.g., bank accounts and other financial information) for the user of client device 110.

Chat engine 232 may include a messaging tool 244 and a fund transfer tool 246.

Messaging tool 244 receives messages or data 226 from a first participant in a chat or conversation via client device 110 and provides messages or data 227, in return, to a second participant in the chat or conversation. Data 226 and 227 may include a fund transfer between the first participant and the second participant, and associated information (e.g., bank accounts, routing numbers, and the like). Fund transfer tool 246 may retrieve information from a fund account of the first participant and the second participant from privacy tool 242 in client device 110. Accordingly, fund transfer tool 246 executes a fund transfer between the fund accounts in the amount specified by the provider (e.g., the first participant). In some embodiments, the information in data 226 and 227 is encrypted such that chat engine 232 does not have access to it, and simply transfers data packets between the associated html addresses for client devices 110 and servers hosting bank accounts and fund transfer applications.

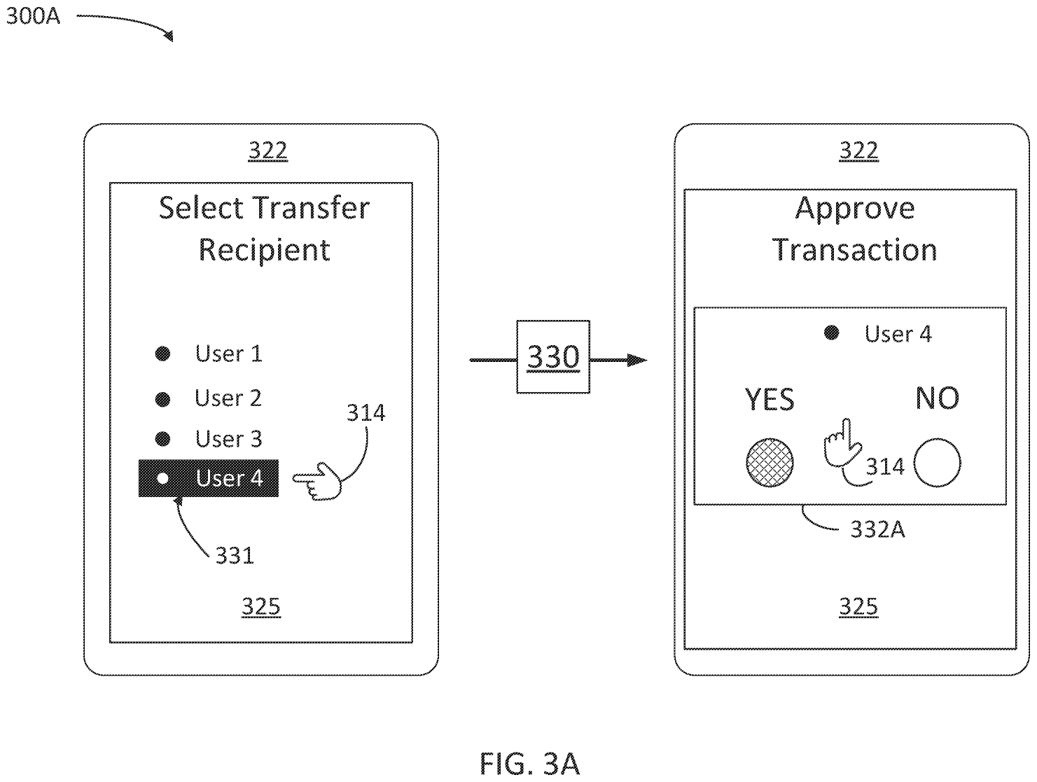

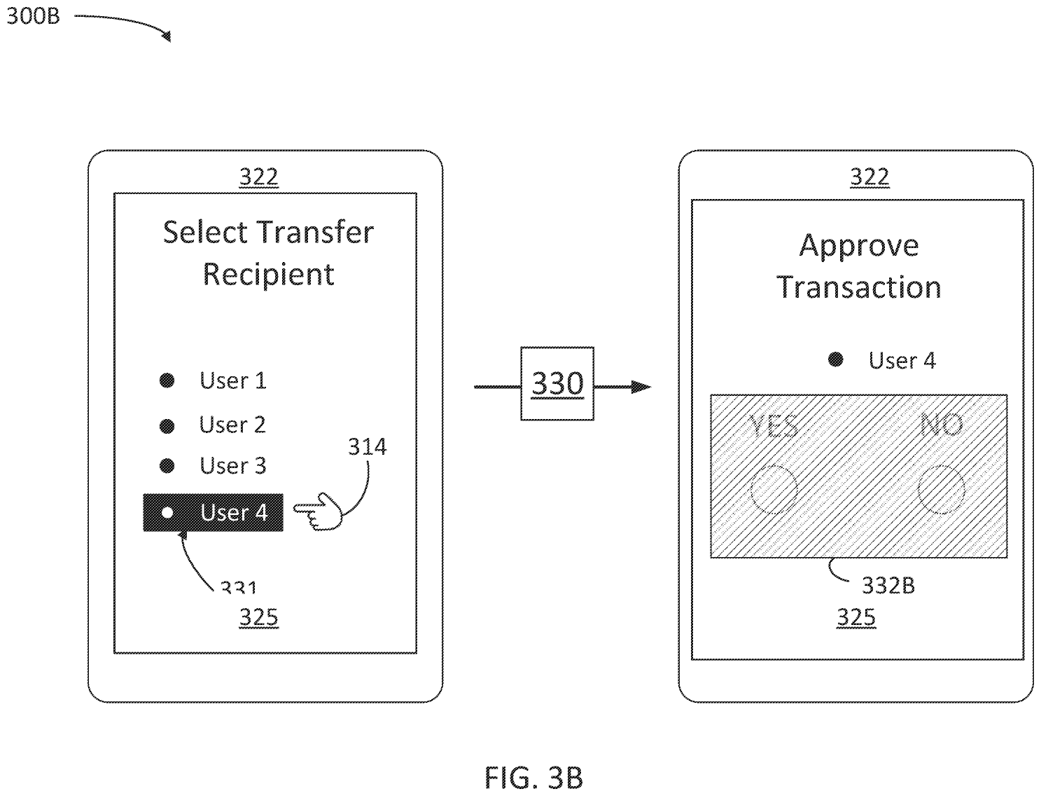

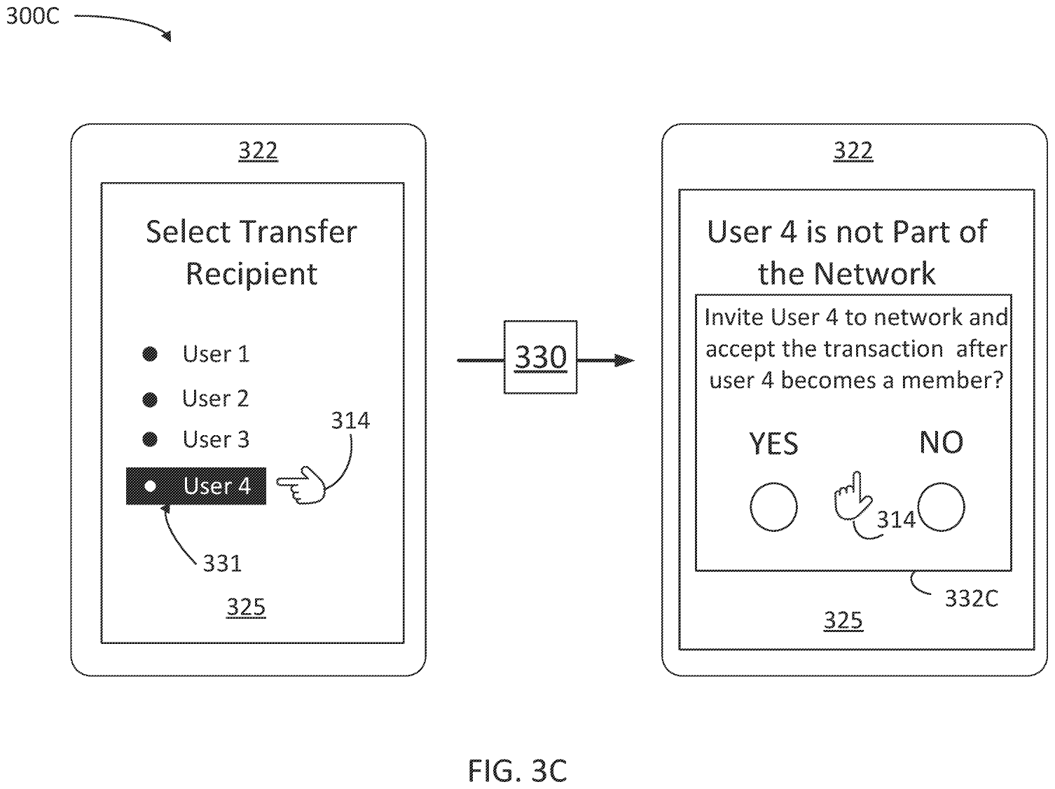

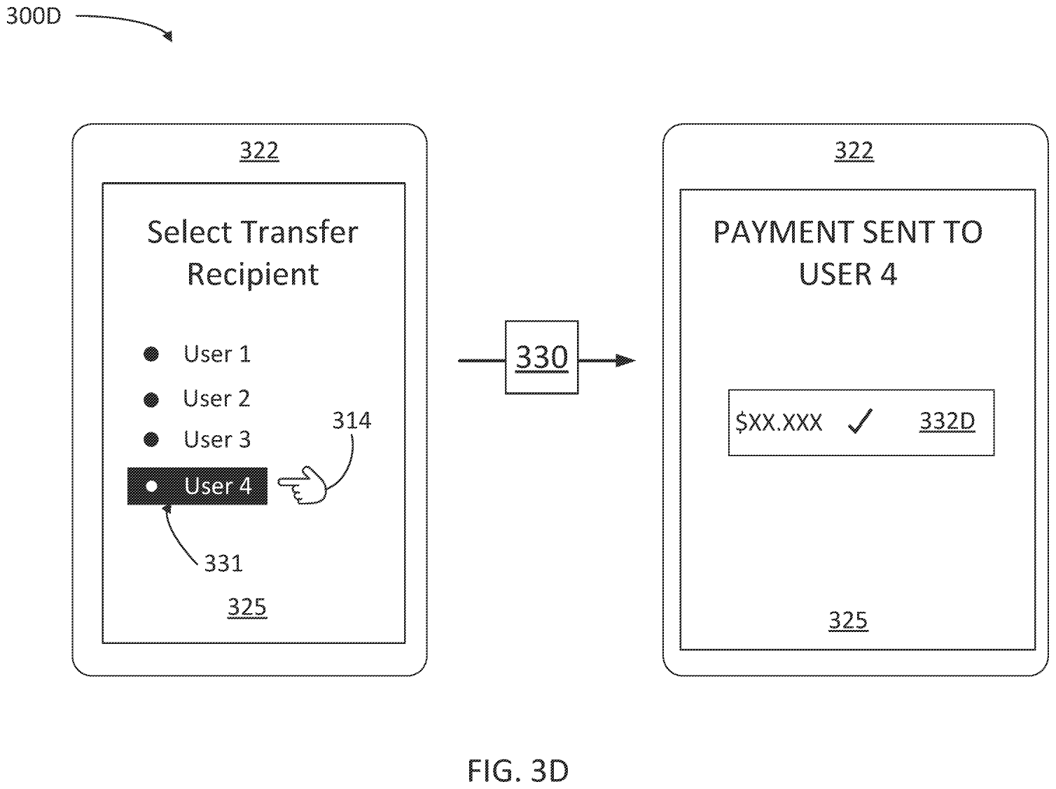

FIGS. 3A-3D illustrate screenshots 300A, 300B, 300C and 300D (hereinafter, collectively referred to as “screenshots 300”) from a messaging application 322 used for peer-to-peer fund transfer between a provider and a transfer recipient, according to some embodiments. Screenshots 300 include fields or “bubbles” with information for the provider or sender of funds. A user of messaging application 322 selects a transfer recipient 331 among a list of users, by clicking with a pointer 314 on the user name provided through a GUI 325.

In screenshots 300A, a server 330 verifies if the transaction with transfer recipient 331 is valid. When it is, messaging application 322 displays a query to “Approve Transaction” by providing a field 332A with “YES” or “NO” buttons for the user to click with pointer 314.

In screenshots 300B, server 330 determines that the transaction is not valid (e.g., transfer recipient 331 has blocked the provider from messaging) and therefore the approval field 332B is disabled (e.g., grayed out). Accordingly, the provider is not able to proceed with the transaction.

In screenshots 300C, server 330 determines that transfer recipient 331 is not a subscriber of messaging application 322. Accordingly, server 330 causes the display in the client device, for the provider, of a query 332C prompting the provider to invite transfer recipient 331 to join and subscribe to messaging application 322. Further, in some embodiments, query 332C further indicates that the transaction will be applied once the transfer recipient has accepted the invitation and becomes a member of messaging application 322.

In screenshots 300D, the fund transfer has been successful, and server 330 provides a message in messaging application 322 informing the sender that the payment to recipient 331 has been sent successfully adding a clear checkmark 332D, for confirmation.

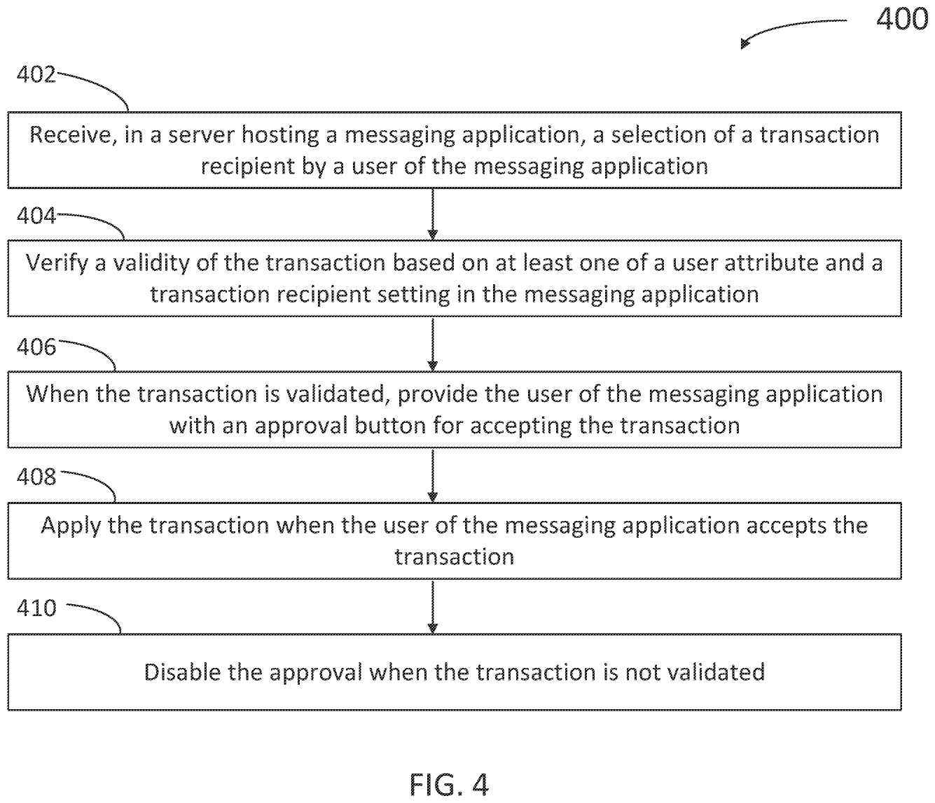

FIG. 4 is a flowchart illustrating steps in a method 400 for handling a peer-to-peer fund transfer between a user and a recipient from a messaging application server, according to some embodiments. In some embodiments, at least one or more of the steps in method 400 may be performed by a processor executing instructions stored in a memory of a client device or server communicatively coupled with one another through a network via communications modules, as disclosed herein (cf. processors 212, memories 220, client device 110, server 130, databases 152 and 252, communications modules 218, and network 150). The memories may include instructions in a messaging application and tools such as an encryption tool, a privacy tool, a messaging tool, or a fund transfer tool, as disclosed herein (cf. messaging application 222, encryption tool 240, privacy tool 242, messaging tool 244, and fund transfer tool 246). Methods consistent with the present disclosure may include at least one or more of the steps in method 400 performed in a different order, simultaneously, quasi-simultaneously, or overlapping in time.

Step 402 includes receiving, in a server hosting a messaging application, a selection of a transaction recipient by a user of the messaging application.

Step 404 includes verifying a validity of the transaction based on at least one of a user attribute and a transaction recipient setting in the messaging application. In some embodiments, step 404 includes verifying that the user of the messaging application is not blocked by the transaction recipient. In some embodiments, the user of the messaging application is in a first jurisdiction and the transaction recipient is in a second jurisdiction, and step 404 includes verifying that the transaction is allowed between the first jurisdiction and the second jurisdiction. In some embodiments, step 404 includes verifying that the user of the messaging application and the transaction recipient belong to a chat group in the messaging application. In some embodiments, step 404 includes verifying that the transaction recipient is subscribed to the messaging application.

In some embodiments, step 404 includes sending the transaction recipient an invitation to subscribe when the transaction recipient is not subscribed to the messaging application.

When the transaction is validated, step 406 includes providing the user of the messaging application with an approval button for accepting the transaction.

Step 408 includes applying the transaction when the user of the messaging application accepts the transaction. In some embodiments, step 408 includes encrypting a dataset with transaction data and transferring the dataset to a funds account of the transaction recipient. In some embodiments, step 408 includes sending the user of the messaging application a link to a third-party fund transfer application. In some embodiments, the transaction is a financial transaction, and step 408 includes transferring a fund into an account of the transaction recipient.

Step 410 includes disabling the approval button when the transaction is not validated.

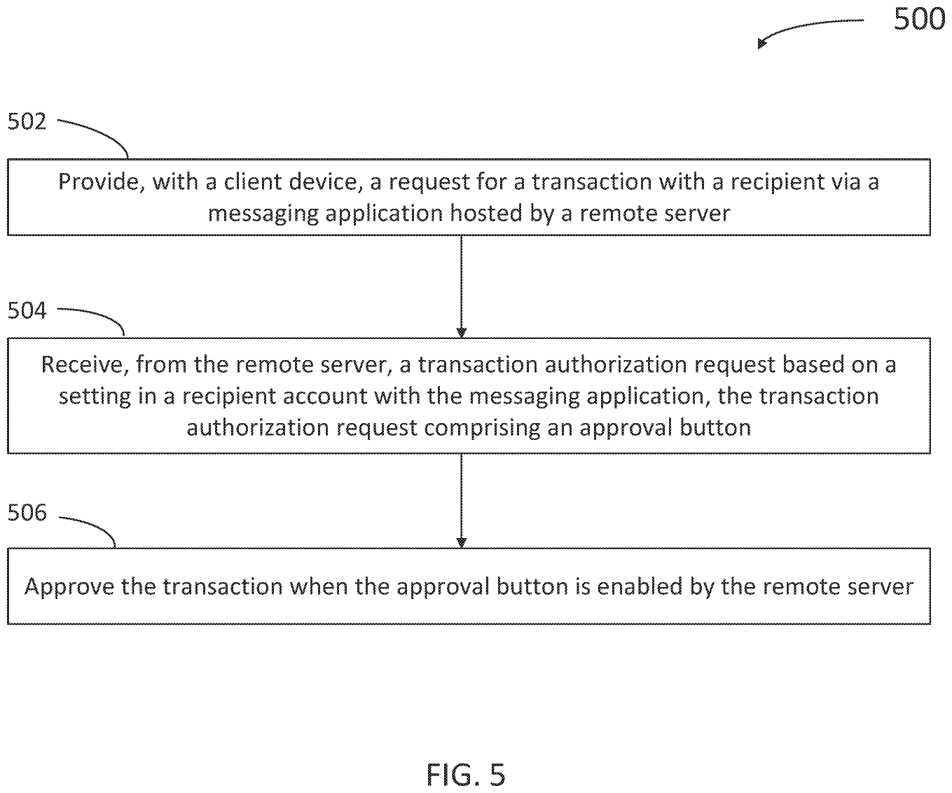

FIG. 5 is a flowchart illustrating steps in a method 500 for transferring funds from a client device using a peer-to-peer messaging application, according to some embodiments. In some embodiments, at least one or more of the steps in method 500 may be performed by a processor executing instructions stored in a memory of a client device or server communicatively coupled with one another through a network via communications modules, as disclosed herein (cf. processors 212, memories 220, client device 110, server 130, databases 152 and 252, communications modules 218, and network 150). The memories may include instructions in a messaging application and tools such as an encryption tool, a privacy tool, a messaging tool, or a fund transfer tool, as disclosed herein (cf. messaging application 222, encryption tool 240, privacy tool 242, messaging tool 244, and fund transfer tool 246). Methods consistent with the present disclosure may include at least one or more of the steps in method 500 performed in a different order, simultaneously, quasi-simultaneously, or overlapping in time.

Step 502 includes providing, with a client device, a request for a transaction with a recipient via a messaging application hosted by a remote server. In some embodiments, the transaction authorization request from the remote server includes an invite recipient to network button, and when the recipient is not subscribed to the messaging application, step 502 includes activating the invite recipient to a network button in the client device.

Step 504 includes receiving, from the remote server, a transaction authorization request based on a setting in a recipient account with the messaging application, the transaction authorization request comprising an approval button. In some embodiments, the approval button in the transaction authorization request is disabled, further comprising receiving, from the remote server, a message indicating that the transaction has been canceled.

Step 506 includes approving the transaction when the approval button is enabled by the remote server. In some embodiments, step 506 further includes receiving, from the remote server, a link to a third-party funding application. In some embodiments, the transaction is a fund transfer, and step 506 further includes allowing the remote server to access a personal fund account to apply the fund transfer to a recipient account.

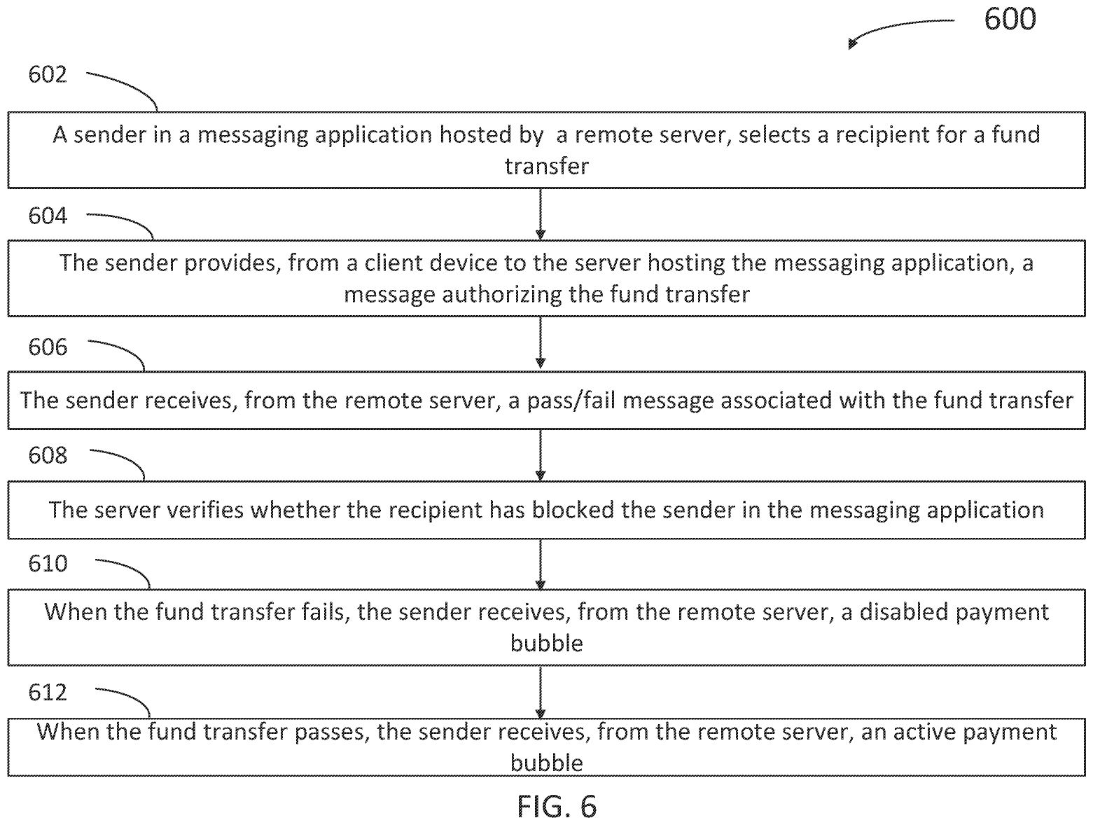

FIG. 6 is a flowchart illustrating steps in a method 600 for transferring funds from a client device using a peer-to-peer messaging application, according to some embodiments. In some embodiments, at least one or more of the steps in method 600 may be performed by a processor executing instructions stored in a memory of a client device or server communicatively coupled with one another through a network via communications modules, as disclosed herein (cf. processors 212, memories 220, client device 110, server 130, databases 152 and 252, communications modules 218, and network 150). The memories may include instructions in a messaging application and tools such as an encryption tool, a privacy tool, a messaging tool, or a fund transfer tool, as disclosed herein (cf. messaging application 222, encryption tool 240, privacy tool 242, messaging tool 244, and fund transfer tool 246). Methods consistent with the present disclosure may include at least one or more of the steps in method 600 performed in a different order, simultaneously, quasi-simultaneously, or overlapping in time.

In step 602, a sender subscribed to the messaging application hosted by a remote server, selects a recipient for a fund transfer.

In step 604, the sender provides, from a client device to the server hosting the messaging application, a message authorizing the fund transfer.

In step 606, the sender receives, from the remote server, a pass/fail message associated with the fund transfer.

In step 608, the server verifies whether the recipient has blocked the sender in the messaging application.

In step 610, when the fund transfer fails, the sender receives, from the remote server, a disabled payment bubble.

In step 612, when the fund transfer passes, the sender receives, from the remote server, an active payment bubble.

### Hardware Overview

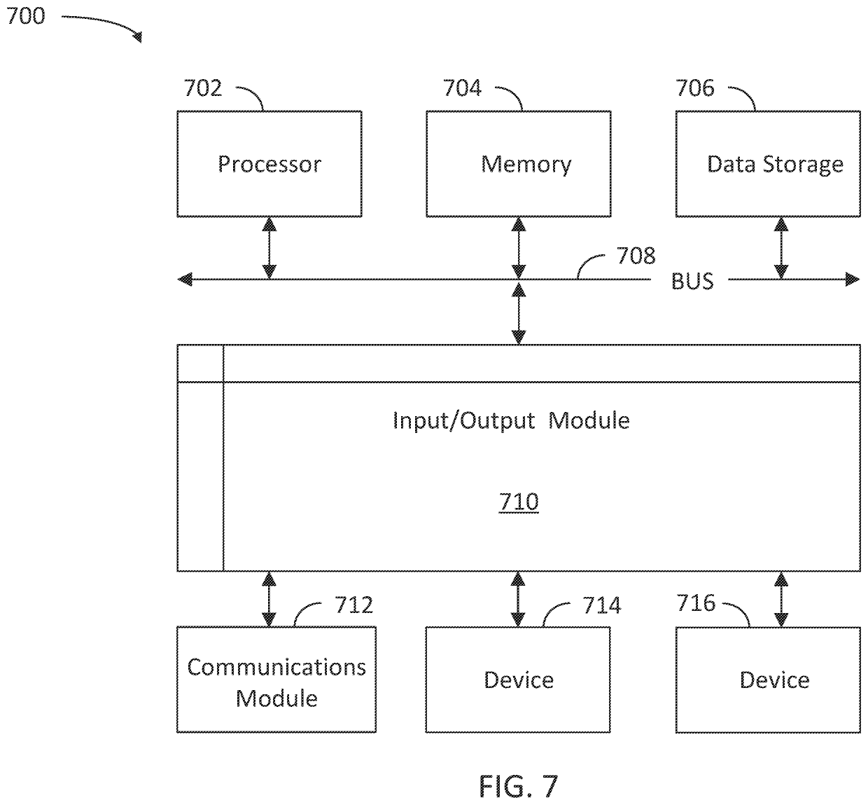

FIG. 7 is a block diagram illustrating an exemplary computer system 700 with which headsets and other client devices 110, and methods 400, 500 and 600 can be implemented. In certain aspects, computer system 700 may be implemented using hardware or a combination of software and hardware, either in a dedicated server, or integrated into another entity, or distributed across multiple entities. Computer system 700 may include a desktop computer, a laptop computer, a tablet, a phablet, a smartphone, a feature phone, a server computer, or otherwise. A server computer may be located remotely in a data center or be stored locally.

Computer system 700 includes a bus 708 or other communication mechanism for communicating information, and a processor 702 (e.g., processors 212) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer-readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled with bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712.

Exemplary communications modules 712 include networking interface cards, such as Ethernet cards and modems. In certain aspects, input/output module 710 is configured to connect to a plurality of devices, such as an input device 714 and/or an output device 716. Exemplary input devices 714 include a keyboard and a pointing device, e.g., a mouse or a trackball, by which a consumer can provide input to the computer system 700. Other kinds of input devices 714 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 716 include display devices, such as an LCD (liquid crystal display) monitor, for displaying information to the consumer.

According to one aspect of the present disclosure, headsets and client devices 110 can be implemented, at least partially, using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all of the words (e.g., instructions, operations, functions, or components) recited in either one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the clauses, such term is intended to be inclusive in a manner similar to the term “include” as “include” is interpreted when employed as a transitional word in a clause. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
receiving, in a server hosting a messaging application, a selection of a transaction recipient by a user of the messaging application;
verifying a validity of the transaction based on at least one of a user attribute, and a transaction recipient setting in the messaging application;
when the transaction is validated, providing the user of the messaging application with an approval button for accepting the transaction;
applying the transaction when the user of the messaging application accepts the transaction; and
disabling the approval button when the transaction is not validated.

2. The computer-implemented method of claim 1, wherein the transaction is a funds transfer, and applying the transaction comprises sending a message to the user of the messaging application confirming that the funds transfer was successful, including a checkmark.

3. The computer-implemented method of claim 1, wherein verifying a validity of the transaction comprises verifying that the user of the messaging application is not blocked by the transaction recipient.

4. The computer-implemented method of claim 1, wherein the user of the messaging application is in a first jurisdiction and the transaction recipient is in a second jurisdiction, and verifying a validity of the transaction comprises verifying that the transaction is allowed between the first jurisdiction and the second jurisdiction.

5. The computer-implemented method of claim 1, wherein verifying a validity of the transaction comprises verifying that the user of the messaging application and the transaction recipient belong to a chat group in the messaging application.

6. The computer-implemented method of claim 1, wherein verifying the validity of the transaction comprises sending the transaction recipient an invitation to subscribe when the transaction recipient is not subscribed to the messaging application.

7. The computer-implemented method of claim 1, wherein applying the transaction when the user of the messaging application accepts the transaction comprises encrypting a dataset with transaction data and transferring the dataset to a funds account of the transaction recipient.

8. The computer-implemented method of claim 1, wherein applying the transaction comprises sending the user of the messaging application a link to a third-party fund transfer application.

9. The computer-implemented method of claim 1, wherein the transaction is a financial transaction, and applying the transaction comprises transferring a fund into an account of the transaction recipient.

10. The computer-implemented method of claim 1, further comprising sending a message to the user of the messaging application that the transaction was canceled, when the transaction is not validated.

11. A system, comprising:
a memory storing multiple instructions; and
one or more processors configured to execute the instructions to cause the system to:
receive, in a server hosting a messaging application, a selection of a transaction recipient by a user of the messaging application;
verify a validity of the transaction based on at least one of a user attribute, and a transaction recipient setting in the messaging application;
when the transaction is validated, provide the user of the messaging application with an approval button for accepting the transaction;
apply the transaction when the user of the messaging application accepts the transaction; and
disable the approval button when the transaction is not validated.

12. The system of claim 11, wherein to verify a validity of the transaction the one or more processors execute instructions to verify that the user of the messaging application is not blocked by the transaction recipient.

13. The system of claim 11, wherein the transaction is a financial transaction, and to apply the transaction the one or more processors execute instructions to transfer a fund into an account of the transaction recipient.

14. The system of claim 11, wherein the user of the messaging application is in a first jurisdiction and the transaction recipient is in a second jurisdiction, and to verify a validity of the transaction the one or more processors execute instructions to verify that the transaction is allowed between the first jurisdiction and the second jurisdiction.

15. The system of claim 11, wherein to verify a validity of the transaction the one or more processors execute instructions to verify that the user of the messaging application and the transaction recipient belong to a chat group in the messaging application.

16. A computer-implemented method, comprising:
providing, with a client device, a request for a transaction with a recipient via a messaging application hosted by a remote server;
receiving, from the remote server, a transaction authorization request based on at least one of a user attribute, and a transaction recipient setting in the messaging application, the transaction authorization request comprising an approval button; and
approving the transaction when the approval button is enabled by the remote server.

17. The computer-implemented method of claim 16, wherein the transaction authorization request from the remote server includes an invite recipient to network button, and when the recipient is not subscribed to the messaging application, further comprising activating the invite recipient to network button in the client device.

18. The computer-implemented method of claim 16, wherein the approval button in the transaction authorization request is disabled, further comprising receiving, from the remote server, a message indicating that the transaction has been canceled.

19. The computer-implemented method of claim 16, further comprising receiving, from the remote server, a link to a third-party funding application.

20. The computer-implemented method of claim 16, wherein the transaction is a fund transfer, further comprising allowing the remote server to access a personal fund account to apply the fund transfer to a recipient account.
